(19) United States
(12) Patent Application Publication
(10) Pub. No.: US 2013/0318450 A1
(43) Pub. Date: Nov. 28, 2013

(54) Method and System for Facilitating Communication Between a Contractor, Sub-Contractor and Clients

(71) Applicant: Co-Construct, LLC, Crozet, VA (US)

(72) Inventor: Donald E. Wyatt, Crozet, VA (US)

(73) Assignee: Co-Construct, LLC, Crozet, VA (US)

(21) Appl. No.: 13/897,496

(22) Filed: May 20, 2013

Related U.S. Application Data
(60) Provisional application No. 61/651,711, filed on May 25, 2012.

(51) Int. Cl. H04L 29/06

(52) U.S. Cl. CPC H04L 65/403
USPC 715/753

(57) ABSTRACT

The present invention provides, in one aspect, a system and method that facilitates communication between multiple classes of users where visibility into all communications is controlled. In one embodiment, the present invention provides a visual interface permitting a contractor user to see which communications are visible to different classes of users or combination thereof. The visual interface receives from the contractor user information as to what participant type is to be included in certain comment threads. In one embodiment of the present invention, each user class is provided with a segmented lane which contains communications that can see seen by that class. In another embodiment of the present invention, comment bubbles containing span the lanes to which that comment is visible.

### FIELD OF THE INVENTION

The present invention relates to communications, and more particularly to electronic communications involving collaborations among multiple parties where selected communications are not revealed to all participants.

### BACKGROUND AND SUMMARY OF THE INVENTION

Work projects that require participation by multiple parties must be managed and coordinated appropriately in order to be effective. There are many industries and business models where work projects not only require participation by multiple parties, but require collaborative communications among the parties. Electronic collaboration can be particularly confusing and frustrating when trying to communicate with only a subset of all of the parties involved.

The present invention provides, in part, a solution to the above issues. The present invention can be applied in any industry with a business model where:
1. A contractor works for a client
2. The contractor communicates with the client
3. The contractor has subcontractors or other involved parties other than the contractor's own staff or the staff of the client
4. The contractor communicates with those subcontractors

The possibility exists, but is not required, that there would be three-way communication between the client, contractor, and at least one of the subcontractors. Residential home construction is just one example of the above.

The present invention provides, in one aspect, a Web-based tool that facilitates communication between multiple (e.g., three) classes of users who should not all have visibility to all communications between the full set of user classes. The present invention further provides a visual way to see which communications are visible to different classes of users such as a contractor, client, subcontractor (referred to as “partners”), or combination thereof. In using the present invention, a first user class such as contractors can select specific users within the partner class to include in certain comment threads. Each user class can have its own vertical “lane” which contains communication that can see seen by that class. In one embodiment of the present invention, “bubbles” containing specific communications span the lanes to which that comment is visible. In an exemplary embodiment, when a contractor user enters a new comment, he/she can click icons representing the client and partner classes, which then makes the comment bubble span the appropriate lanes. When he/she saves the comment, the comment will be visible only to those user classes.

The icons for the other user classes (e.g., client and partner user classes in the above example) can be a specific color, such as black, for example, when that class will not be able to see the comment. The respective icons can be another specific color, such as green, for example, when that user class will be able to see the comment.

In one embodiment of the invention, the visibility of each comment, even in the same conversation thread, is independent of other comments in that same thread.

In one embodiment of the invention, members of the first user class (e.g., the contractor user class) always have visibility to comments (although this is only true for the contractor users with permissions to view the topic to which these comments relate).

In an exemplary embodiment of the invention, client users cannot initiate a conversation with partner users unless the contractor user has previously, on that conversation thread, made at least one comment visible to both the client and partners users.

In an exemplary embodiment of the invention, partner users cannot initiate a conversation with client users unless the contractor user has previously, on that conversation thread, made at least one comment visible to both the client and partners users.

### BRIEF DESCRIPTION OF THE DRAWINGS

FIG. 1 is a schematic diagram of one embodiment of the system of the present invention.

FIGS. 2 through 12 are exemplary visual interfaces showing example communication representations in accordance with aspects of the present invention.

FIGS. 13 through 15 show exemplary visual interfaces as displayed on a mobile device display in accordance with aspects of the present invention.

### DESCRIPTION OF PREFERRED EMBODIMENTS OF THE PRESENT INVENTION

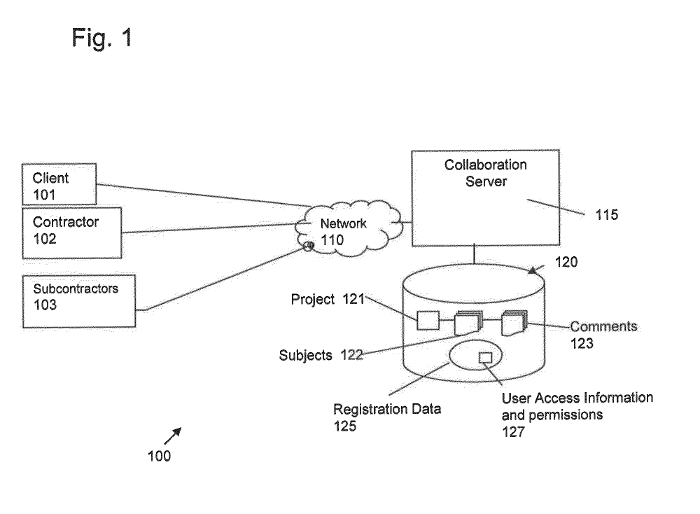

FIG. 1 is a schematic diagram of a system 100 for managing long-running threads for topically organized electronic communications between people in a client-contractor-subcontractor or analogous relationship, where it is desired that different parties have different visibilities to communications based on user type and subject. It will be appreciated that the user class labels of the present invention can be different and involve different types of users beyond clients, contractors and subcontractors, but the terms client, contractor and subcontractor will be used as examples herein for ease of discussion.

In carrying out the above, it will be appreciated that the system of the present invention can comprise a computer-based system, where the components can be implemented in hardware, software, firmware, or combinations thereof.

Users can access the system 100 of the present invention using client computing devices, such as desktop computers, laptop computers, notebooks, tablets and mobile communications devices (MCDs), for example. It will be appreciated that the system of the present invention can incorporate necessary processing power and memory for storing data and programming that can be employed by the processor(s) to carry out the functions and communications necessary to facilitate the processes and functionalities described herein. Each client computing device can be configured to communicate with an application server (not shown) of the system described herein. Appropriate encryption and other security methodologies can also be employed by the system of the present invention, as will be understood to one of ordinary skill in the art. Further, user devices or interfaces can comprise computing devices with multi-modal inputs and outputs, including keyboard, mouse, microphone, touchscreen, and/or gesture inputs, along with visual display and auditory outputs, for example.

Various user types or participants 101, 102, 103 are shown in FIG. 1, and these users can comment on a specific subject within a project via the collaboration server 115 of the present invention, which can be made accessible over a network 110, such as the Internet, for example. It will be appreciated that a participant can use a specially-adapted interface provided in accordance with the present invention based upon the participant's type. For example, the participant may have a client interface 101, a contractor interface 102 or a sub-contractor interface 103 depending upon the participant's role in the collaboration. In one embodiment, the contractor is the highest tier user with the most insight and control into communications made through the system of the present invention.

As further shown in FIG. 1, the present invention can include a data store 120 for housing data related to one or more projects 121. A project can contain one or more subjects 122 that can take many forms, such as a question, a pending decision, or a task, for example. Further, one or more comments 123 can be associated with a subject, and a series of comments on a subject can be considered a “thread.” The project, subject and comment data is stored in data store 120.

As further shown in FIG. 1, the collaboration server 115 of the system of the present invention facilitates online collaboration between the participants. It will be appreciated that an online collaboration session can include multiple modes of communication to support various collaboration activities, and, as such, the system can require multiple collaboration servers running corresponding software applications in one embodiment of the present invention. The collaboration server 115 can prompt and receive information from a contractor or first-tier type participant in order to define one or more projects, the subjects belonging to the project, and messaging rules.

Once a contractor-type participant 102 has defined a project, and one or more subjects belonging to the project, the project and subject(s) are stored in data store 120. Thereafter, registered users can access the project at the discretion of the contractor. In one embodiment of the present invention, the contractor or first-tier type participant establishes rules and protocols via the collaboration server, wherein the rules and protocols are related to the validation of any additional users as a contractor or first-tier type participant, a sub-contractor or second-tier type participant and a client or third-tier type participant. All discussion threads, comprised of comments, pertaining to a given subject or project are also stored in the data store, and are associated with their respective parent subjects.

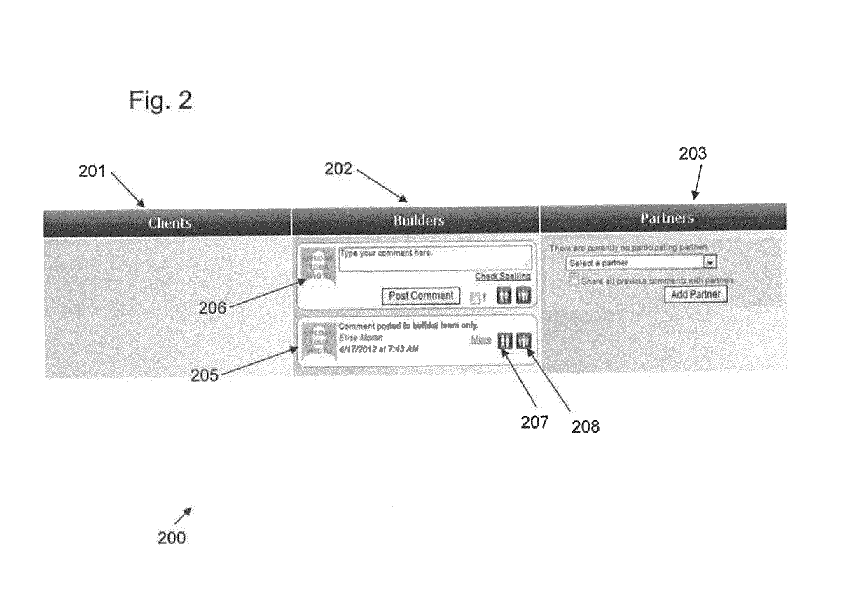

In one embodiment, the present invention can operate such that contractor-type participants 102 may choose to post a comment on a thread that is only visible to other contractor users. In one technical implementation, the system displays the comments within a three-column table or graph 200, as shown in FIG. 2. In this illustrative embodiment, the columns represent the different user types, including a client column 201, a contractor (i.e., “builder”) column 202, and a subcontractor (i.e., “partner”) column 203. In one embodiment of the present invention, the system graphically indicates that the comment is only visible to contractors by having the comment “bubbles” 205, 206 span only the contractor (“builder”) column 202. The client 207 and subcontractor 208 icons shown within the comment bubbles, can also indicate to the contractor that the other user types cannot see the comment. In one embodiment, such notice is provided based on the color of the icons 207, 208. For example, if the icon is colored black, the contractor knows that the specific comment involved is not being shared with that user type, and if the icon is colored green, the contractor knows that the specific comment is being shared with that user type.

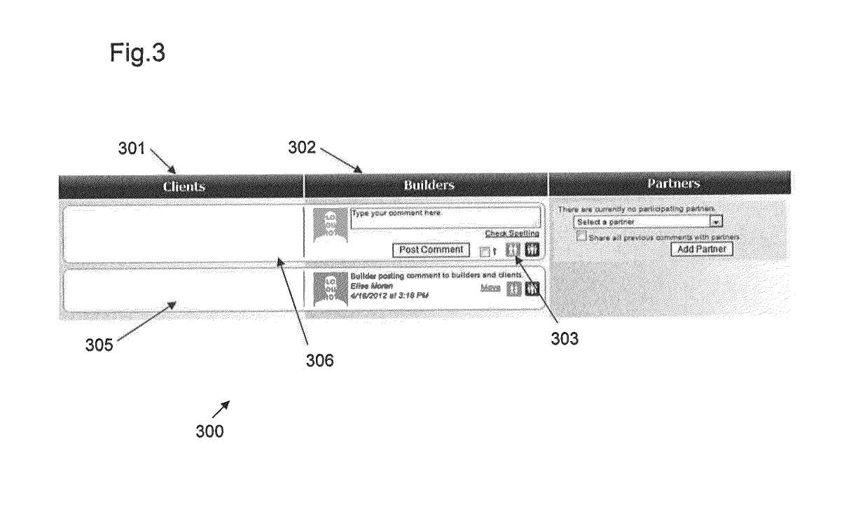

In one embodiment of the present invention, different comments within the same thread can be made visible to different user types, and the visibility permissions and rules can be established by the contractor. In one embodiment of the present invention, contractors always have visibility to all comments on a thread. In another embodiment of the present invention, contractors can establish one or more users participating as a contractor user type. In one embodiment of the present invention, contractors may also choose to post a comment that is visible to the contractor's clients. Multiple users may participate as a client user type, and these users can then see the comment posted by the contractor. In one embodiment of the present invention, as shown in FIG. 3 for example, the present invention provides a graphical indication that the clients can see the comment by color-coding the client icon 303 with a specific color and spanning the comment bubbles 305, 306 over the client 301 and contractor 302 columns.

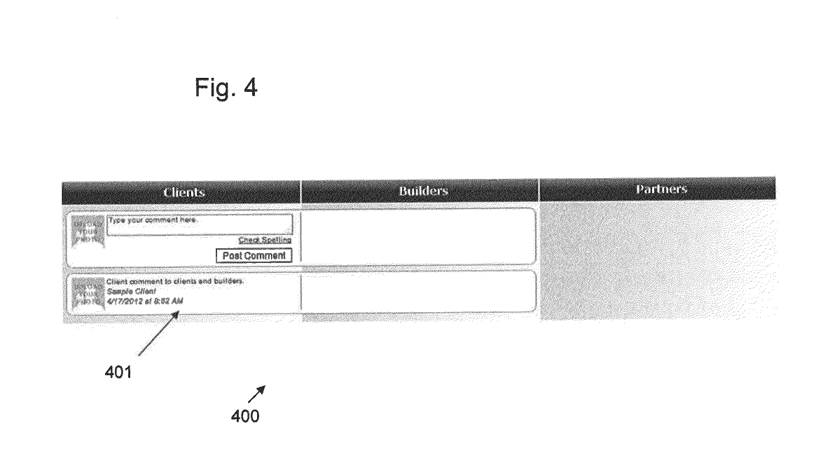

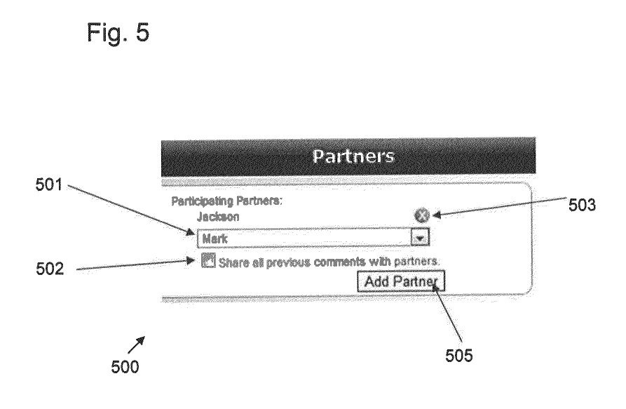

In one embodiment of the present invention, as shown in the diagram 400 of FIG. 4, for example, clients can also post a comment 401 on a thread, and such a comment will always be visible to the other client users and to the contractor users according to the rules established by the contractor. In another embodiment of the present invention, contractors can have multiple subcontractors (also called “partners”) involved in a project. Certain subcontractors may only be involved with certain subjects, and therefore only need to participate in certain comment threads. For example, in the exemplary interface 500 shown in FIG. 5, a contractor can request that the collaboration server provide an interface for the selection of one or more partners who are to receive communications with regard to a particular project, subject or comment. As shown at 501, a partner's name can be selected from a drop-down menu or other input mechanism, and the contractor can then add that partner as through an icon 505, for example. In this way, the selected partner (“Mark” in this case) can have access to a given thread. It will be appreciated that the identification of partners and clients, as well as respective access permissions, can be made through collaboration server by the contractor when initially establishing a project and various potential users who may be designated as a partner/sub-contractor and/or a client. This registration data 125 and permissions 127 are maintained in the data store 120, as illustrated in FIG. 1. With further reference to FIG. 5, the contractor can further indicate as at 502 and through the interface 500, whether to share all previous communications with the identified and selected partners or to only allow the subcontractor to see comments already shared with subcontractors on that thread, if any. Additionally, the contractor can de-select or remove partners as at 503 who had previously been granted access and who may have even contributed comments in the thread. In one embodiment of the present invention, the posts from the subcontractor are still preserved for the contractor even after the subcontractor is removed.

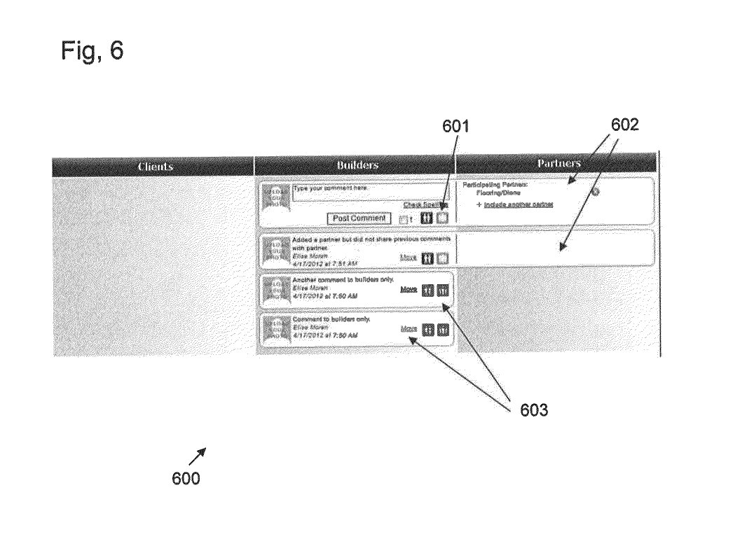

In one embodiment of the present invention, once at least one subcontractor has been added to the thread, the contractor may post a comment that is only visible to the contractor users and to that subcontractor. For example, as shown in exemplary interface 600 of FIG. 6, a graphical indication informs the users that the subcontractor can see the comment. The graphical indication can be provided through color-coding the subcontractor icon as indicated at 601 as well as by spanning the contractor and subcontractor columns with the comment bubbles 602. FIG. 6 also shows that certain comment thread bubbles 603 are not shared with the subcontractor, while other comment threads 602 are.

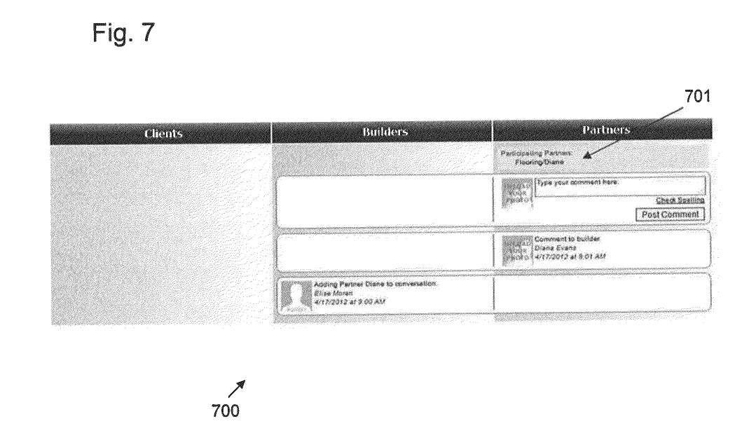

Subcontractors can see and reply to comments on threads to which they have been invited and have comments that are visible to subcontractors. As shown in exemplary interface 700 of FIG. 7, for example, subcontractors may only see part of an overall conversation because not all comments on that conversation have been shared with them. In one embodiment, the subcontractor can also see what other subcontractors, if any, have visibility to comments in the thread, as indicated at 701. In this way, the subcontractor can understand what parties will see his or her comments when providing comments in the thread.

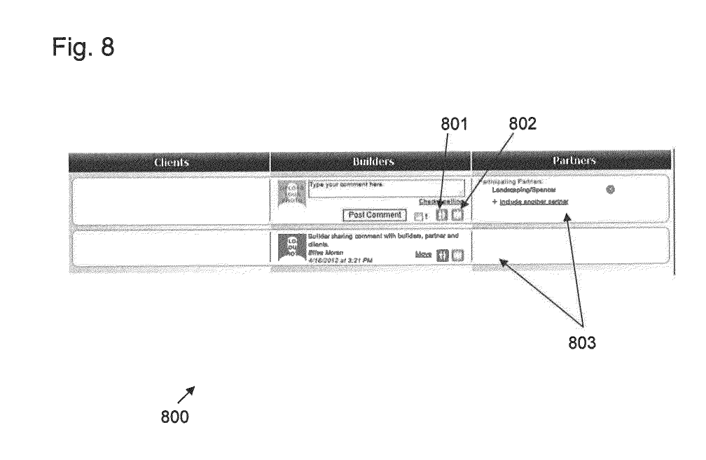

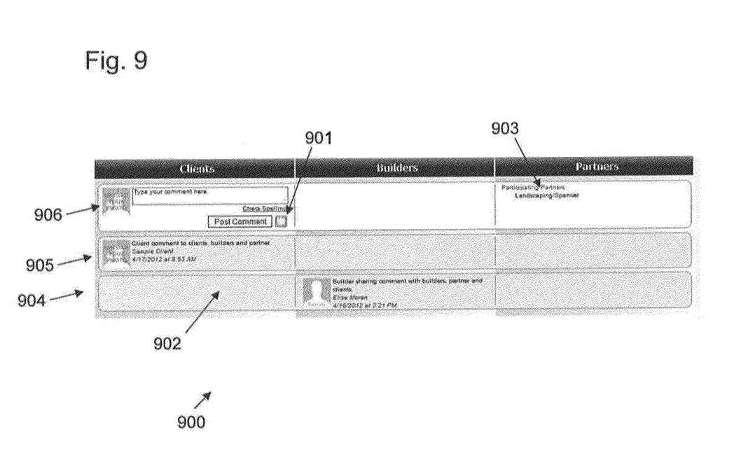

In one embodiment of the present invention, if at least one subcontractor has been given access to a thread, then the contractor may also post a comment that is shared with contractor users, client users, and the participating subcontractors. As shown in illustrative interface 800 of FIG. 8, the user interface graphically indicates the clients and subcontractors can see the comment through color-coding of the client 801 and subcontractor 802 icons and spanning the client, contractor, and subcontractor columns with the comment thread bubbles 803. As indicated by the exemplary interface 900 in FIG. 9, once a comment has been shared with the contractor, client, and subcontractor user types on a specific thread, then client users can use a subcontractor icon signal, button or other notifier 901 to choose to post a comment that is visible to just client and contractor users, or to post a comment that is visible to client, contractor and participating subcontractor users. For example, comments shown in rows 904 and 905 are visible to all participants, as indicated by the comment bubbles extending across all three columns. In comment row 906, the client is given the opportunity using icon 901 to provide the next comment to just the contractor(s) or the contractor(s) and the subcontractor(s). The clients can further see what subcontractors the contractor has selected to participate in the conversation as at 903, and make a decision with regard to whom can view the client's next comment.

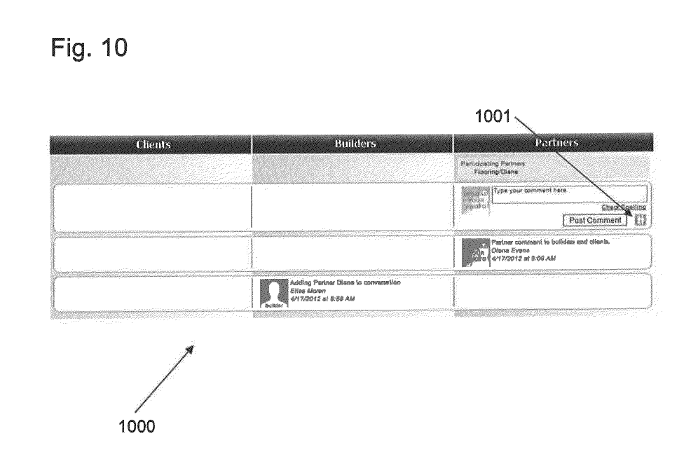

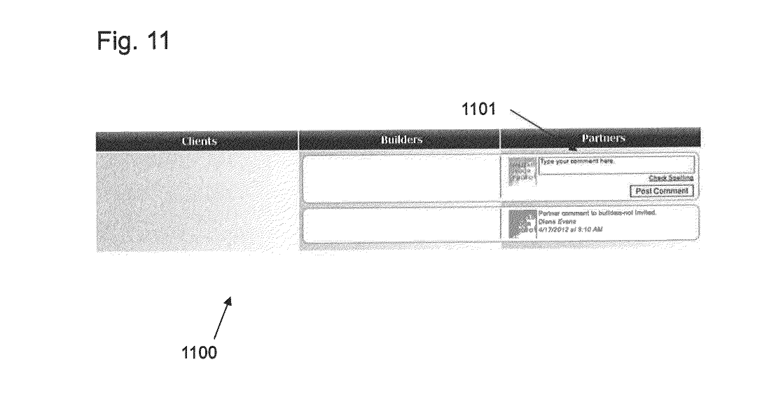

As shown in exemplary interface 1000 of FIG. 10, once a comment has been shared with the contractor, client, and subcontractor user types on a specific thread, then the subcontractor users can use the client icon signal, button or other notifier 1001 to post a comment that is visible to just subcontractor and contractor users or that is visible to subcontractor, contractor, and client users. In one embodiment of the present invention, subcontractors who have visibility to the parent subjects in a project, but who are not invited participants on a given discussion thread, may still post a comment. As shown in exemplary interface 1100 of FIG. 11, for example, the subcontractor will be able to see all of the comments he or she posted, even without being given permission by the contractor to see the comments that are visible to any other participating subcontractors. In one embodiment of the present invention, such uninvited subcontractors will not see a list at the top of their column showing what, if any, other subcontractors have been given permission to see the comments 1101 on that subject.

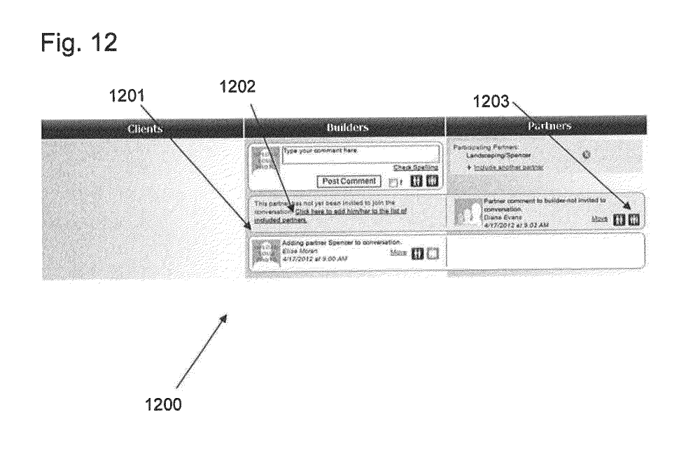

As shown in exemplary interface 1200 of FIG. 12, when an uninvited contractor posts a comment, the contractor sees a special color-coding designation on comments posted by the uninvited subcontractor, as indicated at 1201. The contractor then has the option to invite the subcontractor who posted that comment, as at 1202. Even though the comment is in the subcontractor column, other invited subcontractors cannot see the comment, and this can be visually indicated by the color of the subcontractor sharing icon shown at 1203, unless and until the contractor decides to invite the previously uninvited subcontractor who posted the comment. In one embodiment of the present invention, once a comment has been posted, the contractor can toggle the visibility of the comment on or off for clients and subcontractors. Newly added comments for builders and comments, as defined by user preferences or other business logic rules, can be displayed with a different background color than comments that are not new.

In various aspects of the present invention, certain user actions or other business rules may trigger system-generated comments that can be added to the threads. For example, users may choose to upload an image to be shown alongside comments posted by that user. The present invention can be implemented in accordance with numerous aspects consistent with the material presented herein (e.g., via a web browser interface, a mobile phone, and an email client).

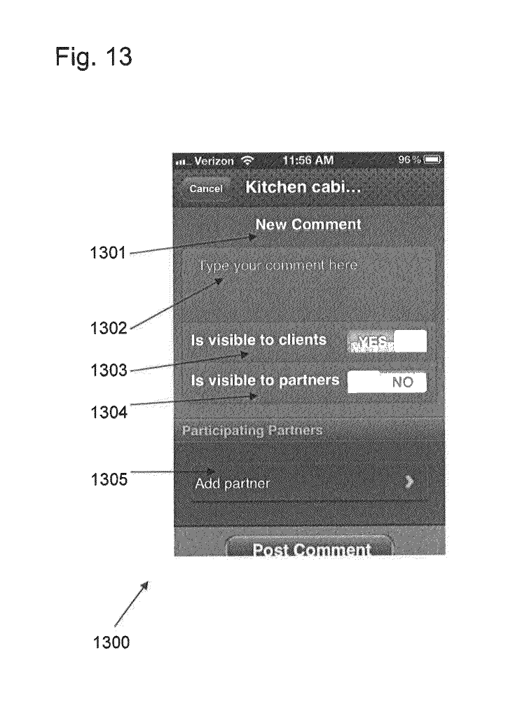

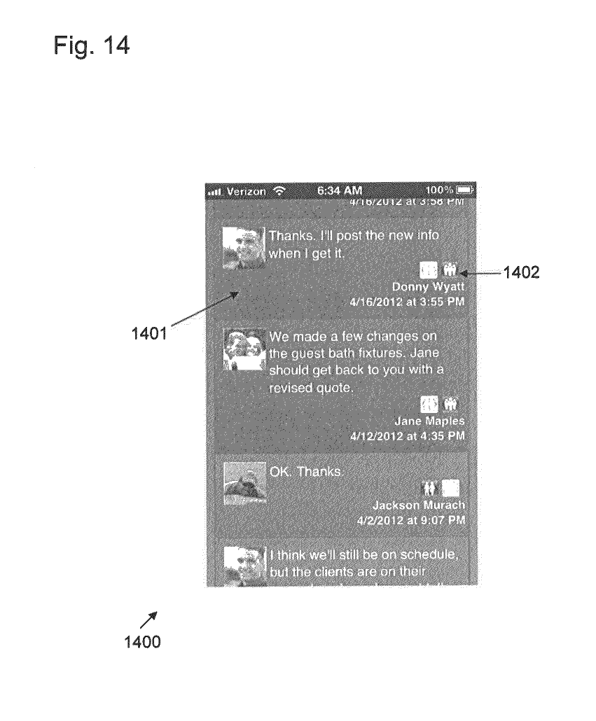

FIG. 13 shows an exemplary interface 1300 of the present invention for a contractor user having a device with a smaller display screen, such as a mobile phone or tablet computer. After navigating to the screen to add a comment to a subject's thread 1301, the user can enter the comment 1302, selects visibility to the client 1303, selects visibility to subcontractors 1304, and adds subcontractors 1305 or removes existing subcontractors as desired. FIG. 14 shows an exemplary interface 1400 displaying an example comment thread summary, including not only the comments posted, but the designation of new comments such as through background coloring 1401 and the visibility of the comments to the different user types 1402.

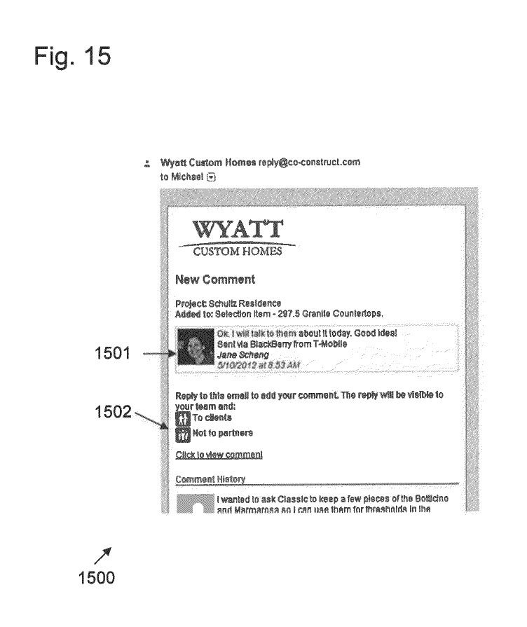

FIG. 15 shows an exemplary interface 1500 according to one embodiment of the present invention whereby client, contractor, and subcontractor users can choose to receive notifications via e-mail about certain comments, based around certain business rules, which may be viewed in HTML or plain text format, for example. The email can include the comment 1501 and indicators 1502 of which user types will be able to see a reply to the comment, which may be the same as the comment that generated the email notification. The user can send a standard email message reply, which the system can then process and attach to the subject's thread with the proper user visibility properties.

Another embodiment of the present invention involves the situation where client, contractor, and subcontractor users can choose to receive notifications about certain comments, based around certain business rules, based on SMS text messages. The user can send a SMS text message reply to this message, which the system processes and attaches to the proper subject's thread, with the proper user visibility properties.

Unless otherwise stated, devices or components of the present invention that are in communication with each other do not need to be in continuous communication with each other. Further, devices or components in communication with other devices or components can communicate directly or indirectly through one or more intermediate devices, components or other intermediaries. Further, descriptions of embodiments of the present invention herein wherein several devices and/or components are described as being in communication with one another do not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media.

Common forms of computer-readable media that may be used in the performance of the present invention include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, EDGE and EVDO.

Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, with programmed steps of the method of the invention for execution by a processing unit. Aspects of the present invention may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example. Appropriate hardware, software and programming for carrying out computer instructions between the different elements and components of the present invention are provided.

The present disclosure describes numerous embodiments of the present invention, and these embodiments are presented for illustrative purposes only. These embodiments are described in sufficient detail to enable those skilled in the art to practice the invention, and it will be appreciated that other embodiments may be employed and that structural, logical, software, electrical and other changes may be made without departing from the scope or spirit of the present invention. Accordingly, those skilled in the art will recognize that the present invention may be practiced with various modifications and alterations. Although particular features of the present invention can be described with reference to one or more particular embodiments or figures that form a part of the present disclosure, and in which are shown, by way of illustration, specific embodiments of the invention, it will be appreciated that such features are not limited to usage in the one or more particular embodiments or figures with reference to which they are described. The present disclosure is thus neither a literal description of all embodiments of the invention nor a listing of features of the invention that must be present in all embodiments.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A method, comprising:
providing at least one processor and a memory that stores instructions which, when executed by the at least one processor, directs the processor to:
receiving and storing at least project, subject and participant information, with the participant information including a designation as to a participant type comprising one of:
contractor, client, subcontractor;
providing a first visual interface through which a contractor participant can enter a contractor comment pertaining to a subject, designate one or more additional participants as having the ability to read the contractor comment and provide an additional participant comment; and
providing at least one second visual interface through which a first one of the one or more additional participants can remove at least a second one of the one or more additional participants from being able to read a comment of the first one of the additional participants.

2. The method of claim 1, wherein the one or more additional participants is a non-contractor, and wherein the at least one second visual interface includes a visual interface for a client participant and a visual interface for a subcontractor participant.

3. The method of claim 1 wherein the first visual interface provides at least two visual indicators for indicating which participant types have current permission to view a comment associated with the subject.

4. The method of claim 3 wherein one of the at least two visual indicators comprises a comment thread bubble extending across one or more columns of the first visual interface.

5. The method of claim 3 wherein one of the at least two visual indicators comprises a color-coded icon.

6. The method of claim 1 wherein the first visual interface can receive an instruction from a contractor type user to expose or share prior communications in a comment thread associated with the contractor comment with one or more non-contractor type participants.

7. The method of claim 1 wherein the first visual interface can receive an instruction from a contractor type user to remove one or more non-contractor type participants from having the ability to read the contractor comment and a comment thread associated with the contractor comment.

8. The method of claim 1 wherein the one or more additional participants includes at least one client participant and at least one subcontractor participant, and wherein the first visual interface includes a first column associated with one or more communications to or from the at least one client participant, a second column associated with one or more communications to or from the contractor participant, and a third column associated with one or more communications to or from the at least one subcontractor participant.

9. The method of claim 8 wherein the first visual interface displays a first indication that a communication to or from the contractor participant is available to the at least one client participant and the at least one subcontractor participant, and further displays a second indication that a communication to or from the contractor participant is not available to at least one of the at least one client participant and the at least one subcontractor participant.

10. The method of claim 1 wherein the at least one third visual interface is a subcontractor interface and includes an indication of one or more subcontractor participants that have received permission to participate in a comment thread associated with the contractor comment.

11. A system, comprising:
at least one processor; and
a memory that stores instructions which, when executed by the at least one processor, directs the processor to:
receive and store at least project, subject and participant information, with the participant information including a designation as to a participant type comprising one of: contractor, client, subcontractor;
provide a first visual interface through which a contractor participant can enter a contractor comment pertaining to a subject, designate one or more additional participants as having the ability to read the contractor comment and provide an additional participant comment; and
provide at least one second visual interface through which a first one of the one or more additional participants can remove at least a second one of the one or more additional participants from being able to read a comment of the first one of the additional participants.

12. The system of claim 11, wherein the one or more additional participants is a non-contractor, and wherein the at least one second visual interface includes a visual interface for a client participant and a visual interface for a subcontractor participant.

13. The system of claim 11 wherein the first visual interface provides at least two visual indicators for indicating which participant types have current permission to view a comment associated with the subject.

14. The system of claim 13 wherein one of the at least two visual indicators comprises a comment thread bubble extending across one or more columns of the first visual interface.

15. The system of claim 13 wherein one of the at least two visual indicators comprises a color-coded icon.

16. The system of claim 11 wherein the first visual interface can receive an instruction from a contractor type user to expose or share prior communications in a comment thread associated with the contractor comment with one or more non-contractor type participants.

17. The system of claim 11 wherein the first visual interface can receive an instruction from a contractor type user to remove one or more non-contractor type participants from having the ability to read the contractor comment and a comment thread associated with the contractor comment.

18. The system of claim 11 wherein the one or more additional participants includes at least one client participant and at least one subcontractor participant, and wherein the first visual interface includes a first column associated with one or more communications to or from the at least one client participant, a second column associated with one or more communications to or from the contractor participant, and a third column associated with one or more communications to or from the at least one subcontractor participant.

19. The system of claim 18 wherein the first visual interface displays a first indication that a communication to or from the contractor participant is available to the at least one client participant and the at least one subcontractor participant, and further displays a second indication that a communication to or from the contractor participant is not available to at least one of the at least one client participant and the at least one subcontractor participant.

20. The system of claim 11 wherein the at least one second visual interface is a subcontractor interface and includes an indication of one or more subcontractor participants that have received permission to participate in a comment thread associated with the contractor comment.
